(19) United States
(12) Patent Application Publication
(10) Pub. No.: US 2023/0044102 A1
(43) Pub. Date: Feb. 9, 2023

(54) ENSEMBLE MACHINE LEARNING MODELS INCORPORATING A MODEL TRUST FACTOR

(71) Applicant: NOBLIS, INC., Reston, VA (US)

(72) Inventors: Janet ANDERSON, Weston, WV (US); Nicholas D. BARTLOW, Morgantown, WV (US); Nathan KALKA, Morgantown, WV (US)

(73) Assignee: NOBLIS, INC., Reston, VA (US)

(21) Appl. No.: 17/557,742

(22) Filed: Dec. 21, 2021

Related U.S. Application Data
(60) Provisional application No. 63/228,379, filed on Aug. 2, 2021.

(51) Int. Cl. G06N 20/20

(52) U.S. Cl. CPC G06N 20/20

(57) ABSTRACT

Methods for improving the prediction accuracy for an ensemble machine learning model are described. In some instances, the methods comprise: (i) receiving data characterizing levels of trust in one or more machine learning models that form the ensemble machine learning model; (ii) calculating a prediction error estimate for each of the one or more machine learning models based on a trust score for that machine learning model and relative weights calculated for the data points in a training data set used to train that machine learning model; (iii) calculating a normalized weight for each of the one or more machine learning models using the prediction error estimate calculated for each; and (iv) adjusting an output prediction equation for the ensemble machine learning model, where the adjustment is based, at least in part, on the normalized weights calculated in for each of the one or more machine learning models.

### CROSS-REFERENCE TO RELATED APPLICATIONS

This application claims the priority of U.S. Provisional Application No. 63/228,379, filed Aug. 2, 2021, the entire contents of which are incorporated herein by reference.

### FIELD

The present disclosure relates generally to methods for detecting and countering adversarial attacks on machine learning models, and more specifically to methods for incorporating a model trust score when training an ensemble machine learning model.

### BACKGROUND

Machine learning (ML) has been adopted across many facets of modern society, with applications ranging from face recognition algorithms used to suggest who to tag in a photo on social media platforms to deep learning algorithms that help with medical diagnoses. While there are a plethora of potential benefits that may be derived from the growing range of ML applications, the increased reliance on ML does not come without risks.

ML algorithms often require vast amounts of data and computational resources to train the machine learning model for a particular application. In order to help alleviate some of the costs associated with data collection and computational resources, publicly available datasets and pre-trained models can be used. While using publicly available datasets and pre-trained models help reduce costs and time, they also come with additional risks. Pre-trained models may be based on data that is not publicly available and/or the source code may not be available to protect intellectual property. This makes it difficult to verify that the model will behave in the expected manner when deployed operationally. If a dataset is large, it can be infeasible to ensure that the dataset is clean and complete. It is known that noisy data, contaminated data, incomplete data, or inherent biases in the data can affect the performance of a machine learning system.

In addition to these non-malicious concerns about machine learning model performance, there are also a growing number of vulnerabilities where an adversary can directly or indirectly attack a ML system such that it affects the system's decision-making outcome. These attacks can be based on the model architecture of the system, the data the system is trained on, or a combination of both. All of these issues lead to concerns about the trustworthiness and accuracy of the machine learning models created.

Ensemble-based machine learning is a common approach that is used to improve accuracy and confidence in ML-based decisions. Ensemble based machine learning is the process of combining multiple models to apply decision-level fusion which can increase the likelihood of making accurate decisions. By using ensemble classifiers, for example, algorithms that are highly accurate but only partially trusted can be incorporated into the ensemble to improve the overall prediction accuracy of the system. Given the primary focus of improved accuracy, little attention has historically been paid to the notion of trust relative to the classifiers incorporated in an ensemble model. Indeed, only a few studies exist that examine the notion of trust for single classifier approaches. Thus, there remains a need to develop methods for incorporating a trust factor in developing and training ensemble machine learning models, and for detecting adversarial attacks that impact the accuracy of the model's predictions.

### SUMMARY

Accordingly, disclosed herein are methods for incorporating a trust factor in developing and training ensemble machine learning models, thereby improving the prediction accuracy of the ensemble model, and for detecting adversarial attacks that impact the accuracy of the model's predictions.

Disclosed herein are methods for calculating a prediction error estimate for a machine learning model comprising: receiving data characterizing a level of trust associated with the machine learning model; training the machine learning model on a training data set to determine relative weights for data points in the training data set; and using the data characterizing the level of trust and the relative weights for at least a subset of the data points in the training data set to calculate a prediction error estimate for the machine learning model, wherein the prediction error estimate increases with a decreasing level of trust.

In some embodiments, the data characterizing the level of trust in the machine learning model comprises a trust score. In some embodiments, the trust score is a real number having a value ranging from 0.0 to 1.0. In some embodiments, the trust score is calculated from the received data. In some embodiments, the received data comprises data relating to a sensitivity of model predictions to input data quality, a sensitivity of model predictions to distributional shifts of training data input, a sensitivity of model predictions to out-of-distribution (OOD) input data, a posterior distribution of model predictions, prediction confidence scores aggregated across one or more training data sets, a ratio of calculated nearest neighbor distances for interclass and intraclass predictions, one or more model performance metrics, or any combination thereof. In some embodiments, the prediction error estimate is calculated using a loss-based penalty function that is based at least in part on the trust score. In some embodiments, the loss-based penalty function comprises a factor of (2−t), where t is the trust score and has a value of 0≤t≤1. In some embodiments, the prediction error estimate (err) calculation comprises a sum of loss-based penalty function terms each comprising a product of a relative weight for a training data point for which the machine learning model prediction was incorrect and a factor of (2−t). In some embodiments, the prediction error estimate (err) is calculated according to the equation:

$$e r r = {\sum }_{i = 1}^{m} {D}_{j} ( i ) ( h ( {x}_{i} ) \neq {y}_{i} ) * ( 2 - t )$$

wherein m is a number of labeled training data point pairs in a training data set used to train the machine learning model, Dⱼ(i) is a normalized weight for an i^{th} training data point of the j^{th} model, (h(xᵢ)≠yᵢ) is a subset of training data points for which the machine learning model's predicted output value, h(xᵢ), does not equal a known value, yᵢ, and t is the trust score. In some embodiments, the machine learning model comprises a classifier model. In some embodiments, the classifier model comprises an artificial neural network (ANN), deep learning algorithm (DLA), decision tree algorithm, Naïve Bayes algorithm, support vector machine (SVM), or k-nearest neighbor (KNN) algorithm.

Also disclosed herein are methods for training an ensemble machine learning model comprising: receiving data characterizing levels of trust in a plurality of machine learning models, wherein the plurality of machine learning models collectively form at least part of the ensemble machine learning model; calculating a prediction error estimate for each machine learning model of the plurality, wherein the prediction error estimate for each machine learning model is based on a trust score for that machine learning model and relative weights calculated for at least a subset of the data points in a training data set used to train that machine learning model; calculating a normalized weight for each machine learning model of the plurality using the prediction error estimate calculated in (b) for each machine learning model of the plurality; and determining an output prediction equation for the ensemble machine learning model, wherein the determination is based, at least in part, on the normalized weights calculated in (c) for each machine learning model of the plurality.

In some embodiments, the data characterizing a level of trust in each machine learning model of the plurality comprises a trust score for each machine learning model of the plurality. In some embodiments, the trust score is a real number having a value ranging from 0.0 to 1.0. In some embodiments, the trust score for each machine learning model of the plurality is calculated from the received data. In some embodiments, the received data comprises data relating to a sensitivity of model predictions to input data quality, a sensitivity of model predictions to distributional shifts of training data input, a sensitivity of model predictions to out-of-distribution (OOD) input data, a posterior distribution of model predictions, prediction confidence scores aggregated across one or more training data sets, a ratio of calculated nearest neighbor distances for interclass and intraclass predictions, one or more model performance metrics, or any combination thereof. In some embodiments, the prediction error estimate is calculated for each machine learning model of the plurality using a loss-based penalty function for that machine learning model that is based, at least in part, on the trust score for that machine learning model. In some embodiments, the loss-based penalty function for each machine learning model of the plurality comprises a factor of (2−t), where t is the trust score for that machine learning model and has a value of 0≤t≤1. In some embodiments, the prediction error estimate calculation for each machine learning model of the plurality comprises a sum of loss-based penalty function terms each comprising a product of a relative weight for a training data point for which that machine learning model prediction was incorrect and a factor of (2−t), where t is the trust score for that machine learning model. In some embodiments, the prediction error estimate for each machine learning model of the plurality is calculated according to the equation:

$$e r r = {\sum }_{i = 1}^{m} {D}_{j} ( i ) ( h ( {x}_{i} ) \neq {y}_{i} ) * ( 2 - t )$$

wherein m is a number of labeled training data point pairs in a training data set used to train a given machine learning model of the plurality of machine learning models, Dⱼ(i) is a normalized weight for an i^{th} training data point for the j^{th} machine learning model, (h(xᵢ)≠yᵢ) is a subset of training data points for which the given machine learning model's predicted output value, h(xᵢ), does not equal a known value, yᵢ, and t is the trust score for the given machine learning model. In some embodiments, the output prediction of the ensemble machine learning model is given by the equation:

$$F ( x ) = sign ( {\sum }_{i = 1}^{N} {w}_{i} {f}_{i} ( x ) )$$

wherein F(x) is a prediction of the ensemble machine learning model for input data value x, N is a number of machine learning models in the ensemble machine learning model, wᵢ are normalized weights for the plurality of machine learning models that collectively form at least part of the ensemble machine learning model, and fᵢ(x) are predictions of the individual machine learning models in the ensemble for input data value x. In some embodiments, the normalized weight, wᵢ, for each machine learning model of the plurality is calculated, at least in part, by taking a natural logarithm of a quotient comprising the prediction error estimate for that machine learning model. In some embodiments, the normalized weight, wᵢ, for each machine learning model of the plurality is calculated, at least in part, according to the equation:

$${w}_{i , n o n - normalized} = \frac{1}{2} ln ( \frac{1 - {err}_{i}}{{err}_{i}} )$$

wherein errᵢ is the prediction error estimate calculated for the i^{th} machine learning model of the plurality, wherein

wᵢ=w_{i,non-normalized}/Σᵢ₌₁^{N}w_{i,non-normalized}

and wherein N is a number of individual machine learning models in the ensemble machine learning model. In some embodiments, the normalized weights for the individual machine learning models of the ensemble machine learning model are calculated by: reformulating the output prediction equation in the form of a quadratic unconstrained binary optimization (QUBO) problem; and using a quantum computing method to solve the QUBO problem for the normalized weights, wᵢ, for the one or more machine learning models. In some embodiments, the method further comprises receiving additional data characterizing levels of trust in one or more machine learning models of the plurality and re-adjusting the output prediction equation for the ensemble if a change in a level of trust is detected for one or more machine learning models of the plurality. In some embodiments, one or more of the machine learning models of the plurality of machine learning models comprises a classifier model. In some embodiments, the classifier model comprises an artificial neural network (ANN), deep learning algorithm (DLA), decision tree algorithm, Naïve Bayes algorithm, support vector machine (SVM), or k-nearest neighbor (KNN) algorithm. In some embodiments, the ensemble machine learning model is trained using an AdaBoost method.

Disclosed herein are methods for training an ensemble machine learning model comprising: receiving data characterizing levels of trust in a plurality of machine learning models, wherein the plurality of machine learning models collectively form at least part of the ensemble machine learning model; training individual machine learning models of the ensemble machine learning model using an AdaBoost method, wherein the training comprises the use of a loss-based penalty function for each machine learning model of the plurality to calculate a prediction error estimate for that machine learning model, and wherein the prediction error estimate is based on a trust score for that machine learning model and relative weights calculated for at least a subset of data points in a training data set used to train that machine learning model; calculating a normalized weight for each individual machine learning model of the ensemble; and determining an output prediction equation for the ensemble machine learning model, wherein the normalized weights calculated for each individual machine learning model are used to formulate the output prediction equation for the ensemble machine learning model.

In some embodiments, the method further comprises formulating the output prediction equation for the ensemble machine learning model as a sum of two terms: an exponential loss function term that provides a measure of a total number of errors made by the ensemble machine learning model as a function of the normalized weights, wᵢ, for the individual machine learning models of the ensemble in predicting a result, y′ₛ, for a given input value, xₛ, when processing a training data set comprising labeled training data points, (xₛ, yₛ); and a regularization term that comprises a product of (i) a sum of non-zero normalized weights, wᵢ⁰, for the individual of machine learning models of the ensemble and (ii) a control variable, λ; and minimizing the two terms of the output prediction equation to determine the normalized weights, wᵢ, for the plurality of machine learning models. In some embodiments, the minimizing is performed by converting the normalized weights, wᵢ, for the plurality of machine learning models to binary values using a binary expansion; rewriting the exponential loss function as a quadratic loss function; expanding and combining the quadratic loss function term, the binary values of the normalized weights, wᵢ, and the regularization term to formulate a quadratic unconstrained binary optimization (QUBO) problem; and solving the QUBO problem using a quantum computing platform. In some embodiments, the ensemble machine learning model is a binary classifier. In some embodiments, the binary values derived from binary expansion of the normalized weights, wᵢ, for the plurality of machine learning models comprise qubits. In some embodiments, the minimum number of qubits, b, required for the binary expansion is given by b≤log₂(f)+log₂(e)−1, where e is Euler's number, f=S/N, S is the number of training data point pairs, and N is the number of individual machine learning models in the ensemble machine learning model. In some embodiments, b<32. In some embodiments, b=1. In some embodiments, the quadratic unconstrained binary optimization (QUBO) is expressed as:

$${w}^{opt} = arg {min}_{w} ( {\sum }_{i = 1}^{N} {\sum }_{j = 1}^{N} {w}_{i} {w}_{j} ( {\sum }_{s = 1}^{S} {h}_{i} ( {x}_{s} ) {h}_{j} ( {x}_{s} ) ) + {\sum }_{i = 1}^{N} {w}_{i} ( λ - 2 {\sum }_{s = 1}^{S} {h}_{i} ( {x}_{s} ) {y}_{s} ) )$$

wherein w^{opt} is a set of optimized weights for a binary classifier which is used to weight predictions of the individual machine learning models. In some embodiments, the method further comprises receiving additional data characterizing levels of trust in one or more machine learning models of the plurality and re-calculating the normalized weight for each individual machine learning model of the ensemble if a change in a level of trust is detected for one or more machine learning models of the plurality. In some embodiments, the quantum computing platform comprises an Amazon Bracket, Azure Quantum, D-Wave, or TensorFlow Quantum computing platform.

Disclosed herein are systems comprising: one or more processors; memory; and one or more programs stored in the memory and comprising instructions that, when executed by the one or more processors, cause the one or more processors to: a) receive data characterizing levels of trust in a plurality of machine learning models, wherein the plurality of machine learning models collectively form at least part of the ensemble machine learning model; b) calculate a prediction error estimate for each machine learning model of the plurality, wherein the prediction error estimate for each machine learning model is based on a trust score for that machine learning model and relative weights calculated for at least a subset of the data points in a training data set used to train that machine learning model; c) calculate a normalized weight for each machine learning model of the plurality using the prediction error estimate calculated in (b) for each machine learning model of the plurality; and d) determine an output prediction equation for the ensemble machine learning model, wherein the determination is based, at least in part, on the normalized weights calculated in (c) for each machine learning model of the plurality. In some embodiments, the one or more programs further comprise instructions that, when executed by the one or more processors, cause the one or more processors to perform any of the methods disclosed herein.

Also disclosed are non-transitory, computer-readable media storing one or more programs, the one or more programs comprising instructions which, when executed by one or more processors of an electronic device or system, cause the electronic device or system to: a) receive data characterizing levels of trust in a plurality of machine learning models, wherein the plurality of machine learning models collectively form at least part of the ensemble machine learning model; b) calculate a prediction error estimate for each machine learning model of the plurality, wherein the prediction error estimate for each machine learning model is based on a trust score for that machine learning model and relative weights calculated for at least a subset of the data points in a training data set used to train that machine learning model; c) calculate a normalized weight for each machine learning model of the plurality using the prediction error estimate calculated in (b) for each machine learning model of the plurality; and d) determine an output prediction equation for the ensemble machine learning model, wherein the determination is based, at least in part, on the normalized weights calculated in (c) for each machine learning model of the plurality. In some embodiments, the one or more programs further comprise instructions that, when executed by the one or more processors, cause the electronic device or system to perform any of the methods disclosed herein.

### INCORPORATION BY REFERENCE

All publications, patents, and patent applications mentioned in this specification are herein incorporated by reference in their entirety to the same extent as if each individual publication, patent, or patent application was specifically and individually indicated to be incorporated by reference in its entirety. In the event of a conflict between a term herein and a term in an incorporated reference, the term herein controls.

### BRIEF DESCRIPTION OF THE FIGURES

Various aspects of the disclosed methods, devices, and systems are set forth with particularity in the appended claims. A better understanding of the features and advantages of the disclosed methods, devices, and systems will be obtained by reference to the following detailed description of illustrative embodiments and the accompanying drawings, of which:

FIG. 1A provides a schematic illustration of where an ensemble-based machine learning model comprising a trust score fits in the adversarial attack landscape.

FIG. 1B provides a schematic illustration of an ensemble-based machine learning model comprising a trust score.

FIG. 2 provides a schematic illustration of using, e.g., the accuracies and trust scores of the individual models that form an ensemble-based machine learning model (1) to adjust model prediction accuracy (2), where a quantum computing approach (3) is used to train the ensemble model.

FIG. 3 provides a schematic illustration of the use of both trusted (C1-C3 and C7-C8) and untrusted (C4-C6) machine learning models can be used to create an ensemble machine learning model where the trust scores for the individual models are used to improve the accuracy of the final prediction.

FIG. 4A provides a schematic illustration of the concepts of accuracy and trustworthiness for machine learning model predictions.

FIG. 4B provides a schematic illustration of an approach for determining a trust score for a classifier based on a nearest neighbor distance calculation for interclass and intraclass predictions for a training data set.

FIG. 5 provides a schematic illustration of a machine learning architecture comprising an artificial neural network with one hidden layer.

FIG. 6 provides a schematic illustration of a node within a layer of an artificial neural network or deep learning algorithm architecture.

FIG. 7 provides a non-limiting example of a workflow for detecting adversarial attacks on an ensemble machine learning model using trust scores, and mitigating the effects of the attack by rapidly updating the output prediction equation for the ensemble model.

FIG. 8 provides a non-limiting example of a computing device in accordance with one or more examples of the disclosure.

FIG. 9 provides a schematic illustration of a quantum computing platform (adapted from Gill, et al. (2020), “Quantum computing: a taxonomy, systematic review and future directions”, arXiv:2010.15559).

### DETAILED DESCRIPTION

The disclosed methods provide a novel approach to securely integrating untrusted machine learning models, e.g., classifiers, in ensemble-based machine learning models to improve the prediction accuracy of the ensemble model and estimate prediction error. By applying a penalty function based on individual classifier trust levels, one is able to incorporate classifiers into an ensemble that individually may often be accurate but may sometimes be untrustworthy. One can then map the process of computing a conditioned weight for the individual machine learning models that factors in the trust component to a problem that can be solved on the hardware of a quantum computer. These conditioned weights from all models in the ensemble can then be fused using a variety of approaches to improve the accuracy and trustworthiness of the ensemble model prediction.

The primary objectives in developing the disclosed methods were to (i) improve the prediction accuracy of ensemble machine learning models that include partially trustworthy models, (ii) increase the reliability and speed with which the conditioning process for adjusting the relative weights for models in the ensemble can be completed by execution on a quantum computing platform, and (iii) develop a means for efficient detection of adversarial activity in ensemble-based artificial intelligence (AI)/machine learning (ML) models that condition the predictions from individual models using a trust score.

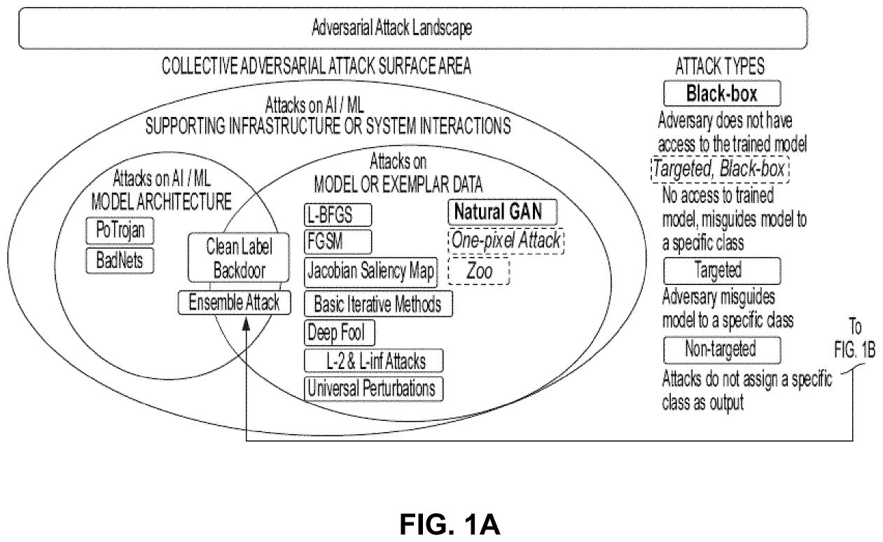

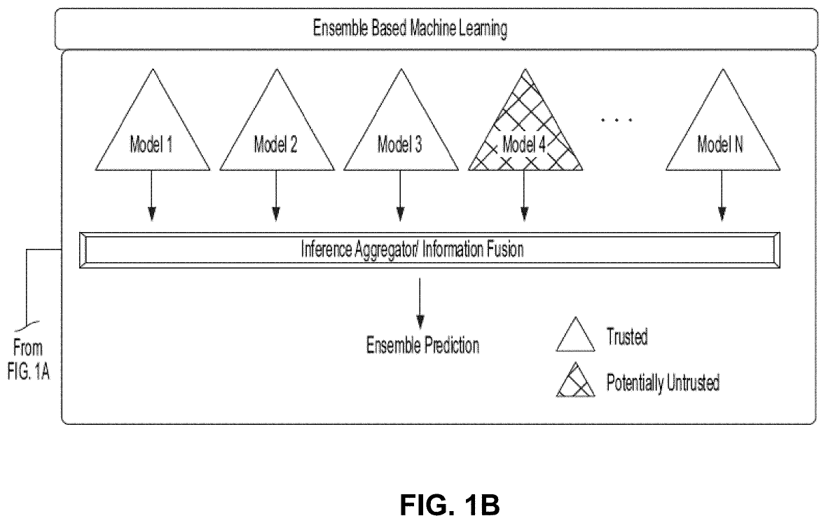

FIG. 1B provides a schematic illustration of an ensemble-based machine learning model comprising a trust score to adjust the relative weight of the individual models in influencing the output prediction of the ensemble model. FIG. 1A illustrates where such ensemble models fit in the adversarial attack landscape. Adversarial attacks may comprise targeted attacks (in which the attack redirects the model prediction to a specific class) or non-targeted attacks (in which the attack does not redirect the model prediction to a specific class) on the model architecture and/or on the model data. “Black box” attacks are attacks in which an adversary does not have access to the trained model. FIG. 1A provides non-limiting examples of attack types that target AI/ML model architecture and those that target the trained model or exemplar data.

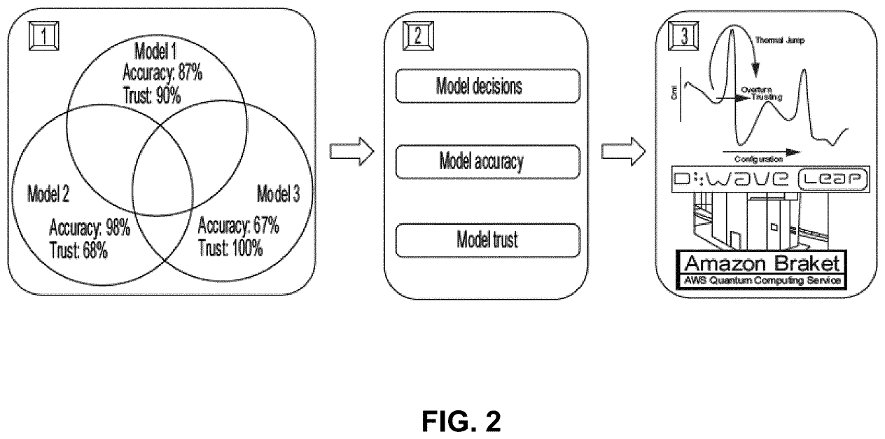

FIG. 2 provides a schematic illustration of using, e.g., the accuracies and trust scores of the individual models that form an ensemble-based machine learning model (1) to adjust model prediction accuracy (2), where a quantum computing approach (3) is used to train the ensemble model. In some instances, the disclosed methods for incorporating a trust score into the training and/or execution of an ensemble machine learning model may enable detection of adversarial attacks.

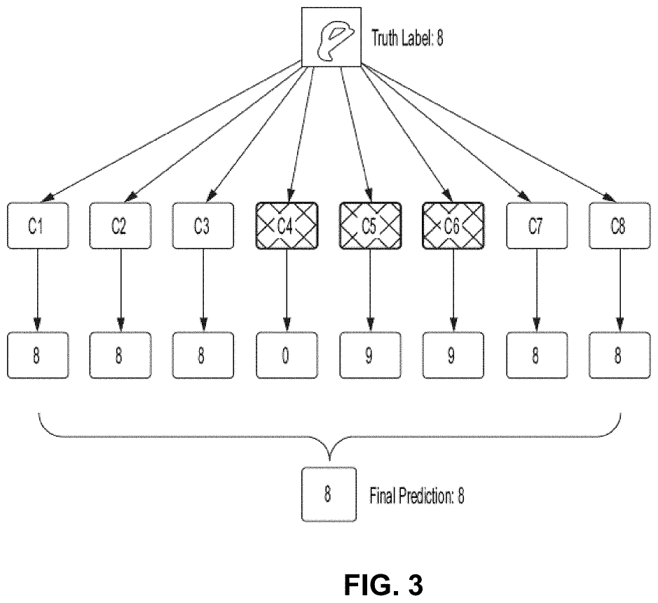

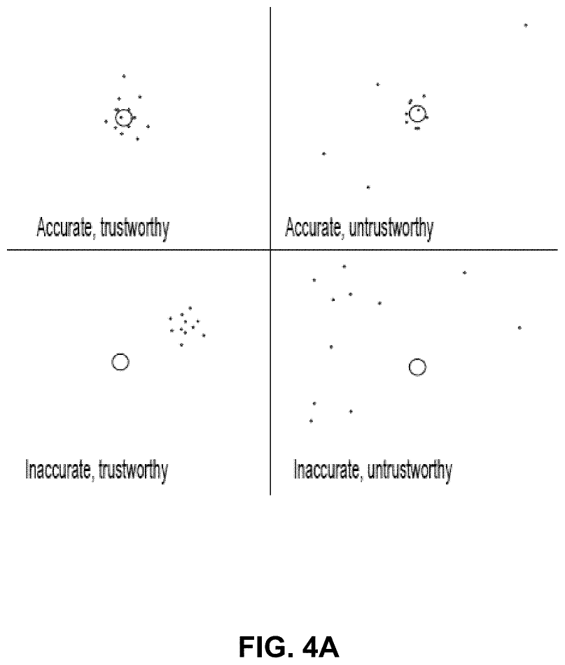

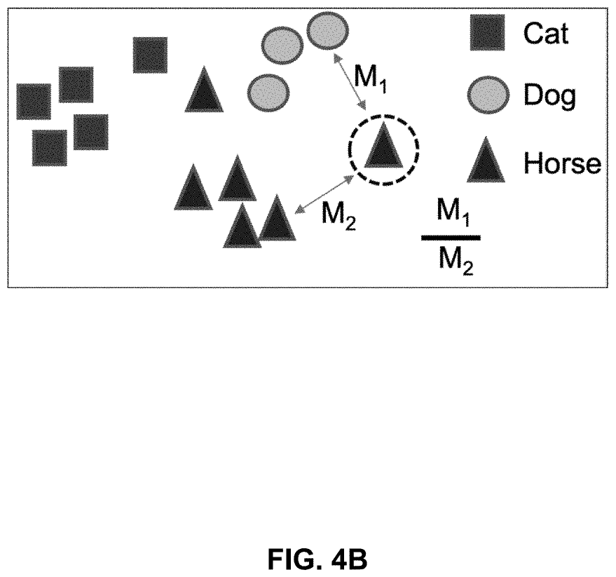

FIG. 3 provides a schematic illustration of the use of both trusted (C1-C3 and C7-C8) and untrusted (C4-C6) machine learning models can be used to create an ensemble machine learning model where the trust scores for the individual models are used to improve the accuracy of the final prediction. In the context of machine learning, the concept of “trust” may be thought of as a characterization of how reliably/consistently a model performs. A trust score can include a measure of the consistency and/or reliability of model predictions. As illustrated in FIG. 4A, “accuracy” (e.g., the circles in FIG. 4A) may be thought of as a measure of the correctness of a model's predictions, while “trustworthiness” (e.g., the points in FIG. 4A) may be thought of as a measure of the precision (or standard deviation) of a model's predictions. As will be discussed in more detail below, the implementation of a new loss function comprising a factor of (2−t), where t is the trust score for an individual model, may be used to calculate the training error exhibited by a given model which in turn may be used to adjust the relative weight of the individual models in influencing the output prediction of the ensemble model.

Ensemble-based machine learning approaches are becoming increasingly popular in the world of machine learning and artificial intelligence applications, and there is a need to know whether or not decisions made by ensemble-based models are trustworthy. Specifically, when constructing an ensemble model one may wish to include, e.g., classifiers that are only moderately accurate but extremely trustworthy, and also classifiers that are usually highly accurate but occasionally untrustworthy. The disclosed methods allow one to integrate these untrustworthy classifiers, and leverage their accuracy when acting in a trustworthy fashion, but discount their predictions when they appear not to be acting trustworthy.

In a first aspect of the present disclosure, a new loss-based penalty function based on a trust score for a given machine learning model is provided for use in evaluating a normalized weight (or weighting factor) for the model when incorporating the model into an ensemble machine learning approach. As noted above, the new loss-based penalty function comprises a factor of (2−t), where t is the trust score for the given model. In some instances, the trust score may be an empirically-derived quantity having, e.g., a real value ranging from 0.0 (untrustworthy) to 1.0 (trusted). In some instances, a trust score may reflect the source and pedigree of a machine learning model rather than its accuracy metrics and may include, for example, verification of the source code for a given model, etc. In some instances, a trust score may be calculated from data received for a given model based on model-dependent and data-dependent factors such as the quality of the data (e.g., the amount of noise in the data, contamination of the data, the completeness of the data, etc.), the sensitivity of the given model architecture to the quality of the data, the frequency of prediction mistakes made by the given model when processing a defined test dataset, etc., or any combination thereof.

Non-limiting examples of approaches that may be used in determining a trust score for a machine learning model have been described in the literature, see for example, Jiang, et al. (2018), “To Trust Or Not To Trust A Classifier”, 32^{nd} Conference on Neural Information Processing Systems (NIPS 2018), Montreal, Canada; and Ovadia, et al. (2019), “Can You Trust Your Model's Uncertainty? Evaluating Predictive Uncertainty Under Dataset Shift”, 33rd Conference on Neural Information Processing Systems (NeurIPS 2019), Vancouver, Canada. Some approaches may include, for example, modeling the posterior probability distributions of classifier predictions and looking at the uncertainty in model predictions to determine a trust score. Other approaches may include, for example, examining prediction confidence scores derived from the model itself, and aggregating confidence scores across a plurality of training data sets to determine a trust score. Yet other approaches may evaluate the robustness of model predictions to distributional shifts of the input data and out-of-distribution (OOD) inputs. In some instances, a trust score may be derived on the basis of one or more model performance metrics, including metrics that do not depend on predictive uncertainty (e.g., classification accuracy), and metrics that do depend on predictive uncertainty (e.g., negative log-likelihood (NLL) and Brier Score (Ovadia, et al. (2019), ibid.).

Another non-limiting example of an approach for determining a trust score (see, e.g., Jiang, et al. (2018), ibid.) involves looking at class boundaries (or decision boundaries) in the training data. As illustrated in FIG. 4B for a multiclass image classifier trained to classify images of dogs, cats, and horses, one may calculate a distance, M₁, between a sample prediction and the closest interclass prediction (i.e., a prediction for a different input sample). One may also calculate a distance, M₂, between the sample prediction and the next closest intraclass prediction (i.e., a prediction for the same class). A trust score for the prediction can then be determined based on the ratio M₁/M₂. Aggregating the trust scores for individual predictions across all input samples may then be used to determine a trust score for the model. In some instances, one may draw on similarities between this approach and applications in Explainable AI, e.g., methods involving heat maps that, if fused with this approach, may lead to a more model-agnostic solution.

In some instances, the trust score may be recalculated for a given machine learning model, e.g., at periodic or random time intervals (or continuously), or based on other triggers, to detect changes in the trust score. In some instances, the detection of a change in the trust score for the given machine learning model may be indicative of an adversarial attack on the machine learning model. Examples of conditions that might trigger a recalculation of trust score include, but are not limited to, a detection of data drift (e.g., if a model's predictions have deviated from the expected results for a submitted set of test data, or if the predictions of an ensemble model no longer reflect the expected output for the training data).

As noted above, the disclosed methods provide for improved accuracy of prediction by ensemble machine learning models that may include partially trustworthy individual models. In some instances, the disclosed methods may comprise adjusting (e.g., automatically adjusting) the relative weights for one or more individual models in an ensemble, e.g., upon detection of a change in one or more of their respective trust scores. In some instances, the disclosed methods may comprise including or excluding (e.g., automatically including or excluding) individual models from the ensemble based on their respective trustworthiness, e.g., based on their respective trust scores or upon detection of a change in their respective trust scores. In some instances, detection of a change in trust score may trigger investigation of a potential adversarial attack. In some instances, detection of a change in trust score may constitute detection of an adversarial attack.

In a second aspect of the present disclosure, a method for incorporating individual model trust scores into an ensemble-based machine learning system to weight their relative contributions and improve the ensemble model's prediction accuracy is disclosed. As will be discussed in more detail below, the trust scores for one or more machine learning models of a plurality of models that collectively constitute an ensemble-based machine learning model may be used to define loss-based penalty functions for each individual model, which in turn may be used to determine normalized weights for the one or more machine learning models of the plurality. The normalized weights may then be used to weight the relative contributions of the individual models to the ensemble model's output prediction. In some instances, the trust score may be recalculated for one or more machine learning models in an ensemble model, e.g., at random or periodic intervals (or continuously), to detect changes in the trust score for the one or more machine learning models. In some instances, the detection of a change in the trust score for one or more machine learning models in an ensemble model may be indicative of an adversarial attack on the one or more machine learning models or on the ensemble model. In some instances, the detection of a change in the trust score for one or more machine learning models in an ensemble model may be used to update the relative weight(s) of the one or more machine learning models and adjust its contribution to the output prediction of the ensemble model.

In a third aspect of the present disclosure, a method for reformulating the trust score-weighted final output prediction equation for an ensemble-based machine learning model as a quadratic unconstrained binary optimization (QUBO) problem that may be solved for the relative weights of the individual models on a quantum computing platform is provided. In some instances, the ability to formulate the trust score-based conditioning of the ensemble model as a QUBO problem suitable for solving with, e.g., Qboost (large scale classifier training with adiabatic quantum optimization) on a quantum computing platform may greatly increase the speed with which the model training converges to a solution. To date, other approaches to factoring in a trust-score in ensemble machine learning have taken other approaches, e.g., application of various neural networks and support vector machines. In some instances, the disclosed methods for formulating the trust score-based conditioning of the ensemble model as a QUBO problem to be solved on a quantum computing platform may allow not only real-time (or near real-time) detection of adversarial attacks on the ensemble model (based on detected changes in trust scores), but also recalculation of the relative weights for the individual models and adjustment of their contributions to the output prediction of the ensemble model in real-time (or near real-time). The disclosed methods and systems thus may provide significant advantages over current methods for detection and mitigation of adversarial attacks on ensemble machine learning models.

Definitions: Unless otherwise defined, all of the technical terms used herein have the same meaning as commonly understood by one of ordinary skill in the art in the field to which this disclosure belongs.

As used in this specification and the appended claims, the singular forms “a”, “an”, and “the” include plural references unless the context clearly dictates otherwise. Any reference to “or” herein is intended to encompass “and/or” unless otherwise stated.

As used herein, the terms “comprising” (and any form or variant of comprising, such as “comprise” and “comprises”), “having” (and any form or variant of having, such as “have” and “has”), “including” (and any form or variant of including, such as “includes” and “include”), or “containing” (and any form or variant of containing, such as “contains” and “contain”), are inclusive or open-ended and do not exclude additional, un-recited additives, components, integers, elements or method steps.

As used herein, the term ‘about’ a number refers to that number plus or minus 10% of that number. The term ‘about’ when used in the context of a range refers to that range minus 10% of its lowest value and plus 10% of its greatest value.

As used herein, the term “accuracy” may refer to a statistical measure of how well a trained binary classification model correctly classifies an input data set into the defined output classes.

As used herein, the term “real-time” may refer to the rate at which data is acquired, input to, and/or processed by a machine learning or artificial intelligence to update, e.g., a prediction, a decision, a control signal, a set of instructions, or other form of output, in response to a change in one or more input data streams such that there is no delay or a minimal delay between a change in one or more input data streams and the update of the prediction, decision, control signal, set of instructions, or other form of output.

As used herein, the term “machine learning” may refer to the use of any of a variety of algorithms known to those of skill in the art that may be trained to process input data and map it to a learned output, e.g., a prediction, decision, control signal, or set of instructions. In some instances, the term “artificial intelligence” may be used interchangeably with the term “machine learning”.

As used herein, the term “neural network” may refer either to a specific machine learning algorithm, e.g., an artificial neural network (ANN) or deep learning algorithm, or more generally to a system, e.g., a cloud-based system, designed to implement any of the machine learning-based methods disclosed herein.

The section headings used herein are for organizational purposes only and are not to be construed as limiting the subject matter described.

Machine learning algorithms: Any of a variety of machine learning algorithms may be used in implementing the disclosed methods and systems, either as stand-alone machine learning models or as components of an ensemble machine learning model. For example, the machine learning algorithm(s) employed may comprise supervised learning algorithms, unsupervised learning algorithms, semi-supervised learning algorithms, deep learning algorithms, or any combination thereof. In some instances, the machine learning algorithm(s) employed may comprise, e.g., an artificial neural network algorithm, a Gaussian process regression algorithm, a logistical model tree algorithm, a random forest algorithm, a fuzzy classifier algorithm, a decision tree algorithm, a hierarchical clustering algorithm, a Naïve Bayes algorithm, a k-nearest neighbor (KNN) algorithm, a k-means algorithm, a fuzzy clustering algorithm, a deep Boltzmann machine learning algorithm, a deep convolutional neural network algorithm, a deep recurrent neural network, or any combination thereof, several of which will be described in more detail below.

Supervised learning algorithms: Supervised learning algorithms are algorithms that rely on the use of a set of labeled training data to infer the relationship between a set of input data, e.g., one or more features for a given image, and a classification of the input data according to a specified set of classes, e.g., images of cats or dogs, or to infer the relationship between a set of input data and a set of user-specified output data types. The training data comprises a set of paired training examples, e.g., where each example comprises a paired set of labeled input and output data points. Examples of supervised machine learning algorithms include artificial neural networks (ANNs) and deep learning algorithms (DLAs).

Unsupervised learning algorithms: Unsupervised learning algorithms are algorithms used to draw inferences from training datasets consisting of pairs of non-labeled input and output data points. One example of a commonly used unsupervised learning algorithm is cluster analysis, which is often used for exploratory data analysis to find hidden patterns or groupings in multi-dimensional data sets. Other examples of unsupervised learning algorithms include, but are not limited to, artificial neural networks, association rule learning algorithms, hierarchical clustering algorithms, matrix factorization approaches, dimensionality reduction approaches, or any combination thereof.

Semi-supervised learning algorithms: Semi-supervised learning algorithms are algorithms that make use of both labeled and unlabeled training data for training (typically using a relatively small amount of labeled data with a larger amount of unlabeled data).

Deep learning algorithms: Deep learning algorithms are algorithms inspired by the structure and function of the human brain called artificial neural networks (ANNs), and specifically, are large neural networks comprising many hidden layers of coupled “nodes” that may be used to map input data to, for example, classification decisions. Artificial neural networks and deep learning algorithms will be discussed in more detail below.

Decision tree-based expert systems: Expert systems are one example of supervised learning algorithms that may be designed to solve classification problems by applying a series of if—then rules. Expert systems typically comprise two subsystems: an inference engine and a knowledge base. The knowledge base comprises a set of facts (e.g., a training data set comprising image feature data for a variety of objects, and the associated object classification data provided by a human observer, etc.) and derived rules (e.g., derived image classification rules). The inference engine then applies the rules to data for a current image classification problem to determine a classification of an object.

Support vector machines (SVMs): Support vector machines are supervised learning algorithms that may be used for classification and regression analysis of, e.g., image feature classification data. Given a set of training data examples (e.g., image feature data sets), each marked as belonging to one or the other of two categories (e.g., good or bad, pass or fail, cat or dog), an SVM training algorithm builds a model that assigns new examples (e.g., feature data for a newly imaged cat or dog) to one category or the other.

k-nearest neighbor (KNN) algorithms: In some cases, the machine learning algorithm used to create an ensemble machine learning model may comprise a k-nearest neighbor (KNN) algorithm. The KNN algorithm provides a non-parametric classification method that is used for both classification and regression. The input consists of the k closest training examples in a training data set. The output depends on whether the algorithm is used for classification or regression. For classification, the output is a class membership whereby an object is assigned to the class most common among its k nearest neighbors, where k is a positive integer. For regression, the output is the property value for the object based on an average of the property values for k nearest neighbors.

Naïve Bayes algorithms: Naive Bayes classifier algorithms are a family of relatively simple “probabilistic classifiers” that are based on applying Bayes' theorem with strong independence assumptions between features. When coupled with kernel density estimations, they can achieve high prediction accuracy levels.

Artificial neural networks and deep learning algorithms: In some cases, the machine learning algorithms used to create an ensemble machine learning model may comprise an artificial neural network (ANN) or deep learning algorithm (DLA). The artificial neural network or deep learning algorithm may comprise any type of neural network model, such as a feedforward neural network, radial basis function network, recurrent neural network, or convolutional neural network, and the like. In some instances, the disclosed methods and systems may employ pre-trained ANN or DLA architecture(s). In some instances, the disclosed methods and systems may employ an ANN or DLA architecture wherein the training data set is periodically or continuously updated with real-time data provided by a single local system, from a plurality of local systems, or from a plurality of geographically distributed systems.

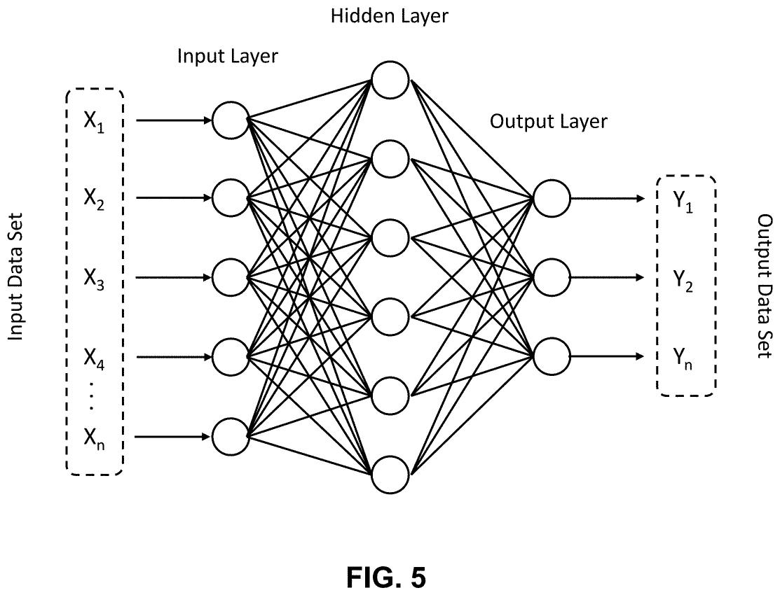

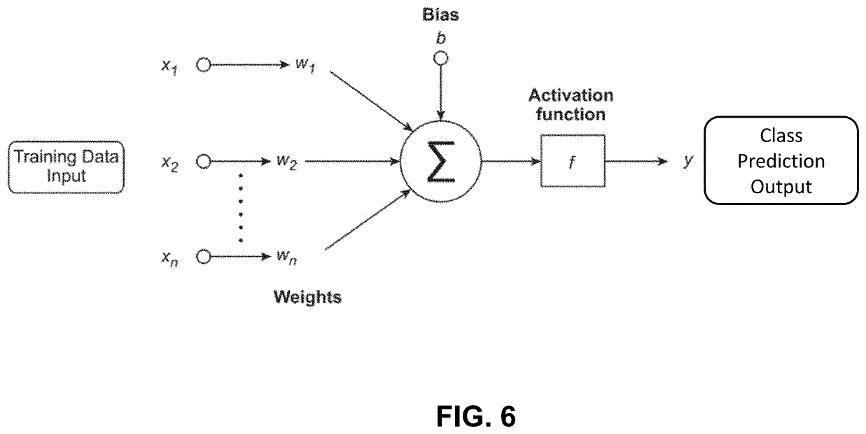

Artificial neural networks generally comprise an interconnected group of nodes organized into multiple layers of nodes. For example, the ANN or DLA architecture may comprise at least an input layer, one or more hidden layers, and an output layer (FIG. 5 and FIG. 6). The ANN or DLA may comprise any total number of layers, and any number of hidden layers, where the hidden layers function as trainable feature extractors that allow mapping of a set of input data to a preferred output value or set of output values. Each layer of the neural network comprises a number of nodes (or neurons). A node receives input that comes either directly from the input data (e.g., object feature data derived from image data) or the output of nodes in previous layers, and performs a specific operation, e.g., a summation operation. In some cases, a connection from an input to a node is associated with a weight (or weighting factor). In some cases, the node may, for example, sum up the products of all pairs of inputs, Xᵢ, and their associated weights, Wᵢ (FIG. 6). In some cases, the weighted sum is offset with a bias, b, as illustrated in FIG. 6. In some cases, the output of a neuron may be gated using a threshold or activation function, f, which may be a linear or non-linear function. The activation function may be, for example, a rectified linear unit (ReLU) activation function or other function such as a saturating hyperbolic tangent, identity, binary step, logistic, arcTan, softsign, parameteric rectified linear unit, exponential linear unit, softPlus, bent identity, softExponential, Sinusoid, Sine, Gaussian, or sigmoid function, or any combination thereof.

The weighting factors, bias values, and threshold values, or other computational parameters of the neural network, can be “taught” or “learned” in a training phase using one or more sets of training data. For example, the parameters may be trained using the input data from a training data set and a gradient descent or backward propagation method so that the output value(s) (e.g., an object classification decision) that the ANN or DLA computes are consistent with the examples included in the training data set. The adjustable parameters of the model may be obtained from a back propagation neural network training process that may or may not be performed using the same hardware as that used for, e.g., processing images and/or performing object characterization.

Other specific types of deep machine learning algorithms, e.g., convolutional neural networks (CNNs) (often used for the processing of image data from machine vision systems) may also be used by the disclosed methods and systems. CNN are commonly composed of layers of different types: convolution, pooling, upscaling, and fully-connected node layers. In some cases, an activation function such as rectified linear unit may be used in some of the layers. In a CNN architecture, there can be one or more layers for each type of operation performed. A CNN architecture may comprise any number of layers in total, and any number of layers for the different types of operations performed. The simplest convolutional neural network architecture starts with an input layer followed by a sequence of convolutional layers and pooling layers, and ends with fully-connected layers. Each convolution layer may comprise a plurality of parameters used for performing the convolution operations. Each convolution layer may also comprise one or more filters, which in turn may comprise one or more weighting factors or other adjustable parameters. In some instances, the parameters may include biases (i.e., parameters that permit the activation function to be shifted). In some cases, the convolutional layers are followed by a layer of ReLU activation function. Other activation functions can also be used, for example the saturating hyperbolic tangent, identity, binary step, logistic, arcTan, softsign, parameteric rectified linear unit, exponential linear unit, softPlus, bent identity, softExponential, Sinusoid, Sine, Gaussian, the sigmoid function and various others. The convolutional, pooling and ReLU layers may function as learnable features extractors, while the fully connected layers may function as a machine learning classifier. As with other artificial neural networks, the convolutional layers and fully-connected layers of CNN architectures typically include various adjustable computational parameters, e.g., weights, bias values, and threshold values, that are trained in a training phase as described above.

Regularization and sparsity constraints: In some machine learning approaches, e.g., those comprising the use of an ANN or DLA model, regularization and/or application of sparsity constraints may be utilized to improve the performance of the model. For example, regularization is often used in the field of classification. Empirical training of classification algorithms, based on “learning” using a finite data set, generally poses an underdetermined problem as the algorithm is attempting to infer a function f(x) of any given input value, X, based on a discrete set of example input values X₁, X₂, X₃, X₄, etc. In some cases, L1 regularization, L2 regularization, or other regularization schemes may be employed. In some cases, for example when using an autoencoder architecture, a sparsity constraint that limits the number of non-zero coefficients (or trainable parameters) in the model may be imposed on the hidden layers to limit the number of active hidden layers or nodes, and thereby enhance the ability of the autoencoder to discover interesting structure in the input data set even if the number of hidden layers is large. A node may be thought of as being “active” if its output value is close to 1, or as being “inactive” if its output value is close to 0 (assuming that a sigmoid activation function is used). Application of a sparsity constraint limits the nodes to being inactive most of the time, e.g., by setting the activation coefficient to be a function of the input value and dependent on a sparsity parameter typically having a small value close to zero (e.g., 0.05).

Training data sets: As noted above, the type of training data used for training a machine learning algorithm for use in the disclosed methods and systems will depend on, for example, whether a supervised or unsupervised approach is taken as well as on the specific application to be addressed. In some instances, one or more training data sets may be used to train the algorithm in a training phase that is distinct from that of the application or use phase. In some instances, the training data may be periodically or continuously updated and used to update the machine learning algorithm periodically or in real time. In some cases, the training data may be stored in a training database that resides on a local computer or server. In some cases, the training data may be stored in a training database that resides online or in the cloud.

In some instances (e.g., for training multiclass AdaBoost classifiers), the training data (or test data) may comprise data sets derived from, e.g., MNIST (a large database of handwritten digits; http://yann.lecun.com/exdb/mnist/), IJB-C (an unconstrained face image data set comprising more than 100,000 face images and videos; https://www.nist.gov/programs-projects/face-challenges), ImageNet (a database comprising approximately 14 million images of animals, flowers, objects, people, etc.; https://www.image-net.org/index.php), or CIFAR-10 (a large data set comprising about 60,000 color images; https://www.cs.toronto.edu/·kriz/cifar.html). For applications that require binary classification, a subset of data derived from these databases, or a modified portion thereof, may be used. Most of these examples come from the computer vision/image classification domain but could be extended other application domains as well. Such data sets may be used to benchmark a given model's performance against other models, or could also be used as standard test data set.

In the case of ensemble machine learning approaches, in some instances each individual machine learning model of the ensemble may be trained separately. In some instances, the individual machine learning models may be trained sequentially in a specified order using, e.g., an AdaBoost algorithm, with the training output of a previous model used to adjust the relative weights of the training data points used to train the next successive model. After training, the training weights are updated based on the misclassifications of the model that was just trained. From this, each model currently used in a given instance of the ensemble will be assigned a weight for any predictions that the model makes. The final prediction for the AdaBoost ensemble model is based on the weight sum predictions of all individual models currently used.

Machine learning software: Any of a variety of commercial or open-source software packages, software programming languages, or software platforms known to those of skill in the art may be used to implement the machine learning models, including ensemble machine learning models, of the disclosed methods and systems. Examples of suitable programming languages include, but are not limited to, Java (www.java.com), Javascript (www.javascript.com), and Python (www.pytho.org). Examples of software packages and platforms include, but are not limited to, Shogun (www.shogun-toolbox.org), Mlpack (www.mlpack.rog), R (r-project.org), Weka (www.cs.waikato.ac.nz/ml/weka/), Matlab (MathWorks, Natick, Mass., www.mathworks.com), NumPy (https://numpy.org/), SciPy (https://www.scipy.org/), scikit-learn (https://www.scikit-learn.org/stable/), Theano (https://pypi.org/project/Theano/), TensorFlow (https://www.tensorflow.org/), Keras (https://keras.io/), PyTorch (https://pytorch.org/), and/or Pandas (https://pandas.pydata.org/).

Machine learning models and trustworthiness: Given the rapidly growing use of artificial intelligence and machine learning in a wide variety of applications and industries, knowing when a machine learning model's predictions can be trusted is becoming increasingly critical (Jiang, et al. (2012), “To trust or not to trust a classifier”, 32nd Conference on Neural Information Processing Systems (NIPS 2018), Montreal, Canada). A standard approach to deciding whether to trust a model's output or predictions is to use the model's own reported confidence score, e.g. probabilities from the softmax layer of a neural network (i.e., a layer that executes the softmax function to convert a set of real valued input values to a set of normalized probability values), the distance to the separating hyperplane in support vector classification, or mean class probabilities for the trees in a random forest. Recently, Jiang, et al. (2018) defined a trust score for determining whether to trust a single classifier's prediction as the ratio between the distance from a testing sample to the nearest class different from the predicted class and the distance to the predicted class.

Ensemble machine learning models: Ensemble learning is an approach in which multiple machine learning models, e.g., classification models (also referred to herein as “classifiers”) or expert systems, are combined to solve particular computational problems with the goal of achieving better model performance (e.g., better classification performance, predictive performance, function approximation, etc.) (Polikar (2009), “Ensemble learning”, Scholarpedia, 4(1):2776).

One such ensemble method is boosting. A boosting method seeks to improve predictions by iteratively combining the models such that each model is trained on the errors of the previous model, with the objective of converting a series of “weak learners” (e.g., classifiers that may only be moderately accurate) into a “strong learner” (e.g., a classifier that is highly accurate). Examples of boosting algorithms include, but are not limited to, AdaBoost, LPBoost, TotalBoost, BrownBoost, xgboost, MadaBoost, LogitBoost, and the like.

In some instances, an ensemble machine learning model may comprise 2, 3, 4, 5, 6, 7, 8, 9, 10, 20, 30, 40, 50, 60, 70, 80, 90, 100, or more than 100 individual machine learning models. In some instances, an ensemble machine learning model may comprise any number of machine learning models within the range of values included in this paragraph.

AdaBoost: AdaBoost, which stands for “adaptive boosting”, was the first adaptive boosting algorithm and remains one of the most widely adopted boosting algorithms. AdaBoost was first proposed by Freund & Schapire in 1996 (Freund & Schapire, “Experiments with a New Boosting Algorithm”, Machine Learning: Proceedings of the Thirteenth International Conference, 1996). The final classification equation for AdaBoost can be represented as:

$$F ( x ) = sign ( {\sum }_{i = 1}^{N} {w}_{i} {f}_{i} ( x ) )$$

Here, fᵢ represents the ith weak classifier, wᵢ represents the weight for the ith weak classifier, and N represents the total number of classifiers (which does not need to be known ahead of time).

To obtain the final classification equation for AdaBoost, the AdaBoost algorithm must be performed. Assume that one is given a finite number of training examples m, say (x₁, y₁), (x₂, y₂), . . . , (xₘ, yₘ), where x∈ [symbol] ^{d} and y∈{−1, 1}. Let D₁(i)=1/m for i=1, 2, . . . , m. D₁ represents the initial weight for each data point, where every data point is weighted equally. Next, fit a weak classifier, h, to the dataset to adjust the relative weights, D(i), for each training data point to be used in training the next model in the series. The error is then calculated by:

$$e r r = {\sum }_{i = 1}^{m} {D}_{j} ( i ) ( h ( {x}_{i} ) \neq {y}_{i} )$$

where Dⱼ(i) are the relative weights for the training data points in the j^{th} model.

The error is the sum of the weights for incorrect predictions. The weight for the individual weak classifier, wᵢ, is then calculated by:

$$w = \frac{1}{2} ln ( \frac{1 - e r r}{e r r} )$$

The weight will be positive when the accuracy (inversely proportional to the error) is greater than 50%, and negative when the accuracy is less than 50%. The more accurate the classifier is, the greater its weight, and the less accurate the classifier is, the lesser its weight will be.

The weight of each data point is updated prior to the fitting of the next model by: Dⱼ(i)=

The weights for each data point are then normalized by setting: Dⱼ(i)=Dⱼ(i)/Σᵢ₌₁^{m}Dⱼ(i).

Assume that the accuracy for the classifier just fitted is greater than 50%. Then w will be positive. When yᵢ and h(xᵢ) agree (i.e., the classification prediction is correct), then exp(−w) will be small (less than 1). When yᵢ and h(xᵢ) do not agree (i.e., the classification prediction is incorrect), then exp(w) will be larger (greater than 1). Thus, the weight of a misclassified data point will be increased during the weight update before the next model is fitted, while the weight of a correctly classified data point will be decreased. The weights are then normalized to keep the total sum of the weights equal to 1.

After the AdaBoost algorithm has been completed, the final ensemble prediction equation is determined as indicated above. Notice that the wᵢ represent weighted error rates for classifiers fᵢ in the ensemble, as determined from the algorithm. The more accurate an individual classifier is, the greater weight it will have in the ensemble prediction.

Implementing a trust component into an ensemble machine learning model: AdaBoost has been interpreted as a stage-wise estimation procedure for fitting an additive logistic regression model using an exponential loss function (Friedman, et al. (2000), “Additive logistic regression: a statistical view of boosting”, The Annals of Statistics 28(2):337-407).

Using this interpretation, a trust component can be added to the AdaBoost algorithm. Assume that each weak classifier of an ensemble are given a trust score in the range [0, 1.0]. In some instances, a trust score may be calculated for each classifier as described elsewhere herein. A trust score of 1.0 corresponds to a classifier that is completely trusted, while a lower trust score would correspond to an untrustworthy classifier. The trust score is implemented by incorporating it into the error calculation stage. The new error function for the j^{th} model becomes:

$$e r r = {\sum }_{i = 1}^{m} {D}_{j} ( i ) ( h ( {x}_{i} ) \neq {y}_{i} ) * ( 2 - t )$$

where t is the trust score. By implementing the trust score, a classifier is punished for making incorrect predictions based on the trust of the classifier. For instance, a classifier that is completely trusted (t=1) is not penalized, and the error for that classifier will remain the same as calculated in the original AdaBoost algorithm. In the extreme case that the classifier is not trusted at all (t=0), the calculated error for that classifier becomes twice the original error. Assuming that the individual classifiers are weak (i.e., the accuracy of each model is greater than 50%), then the error should be at most

$$\frac{1}{2} - ε$$

for some ε>0. Using these assumptions, then err <1 even in the extreme case. It is important that err <1 since the natural log function is not defined at 0.

Assuming that the trust score is not 1, the equation above yields a larger calculated error for each classifier based on its trust score, which in turn affects the weight for each weak classifier in the ensemble. A model that was highly accurate but also highly untrustworthy will be weighted as a less accurate model. This corresponds to the model weighting the incorrect predictions' data points higher for the next classifier to train on, and also the classifier's weight will be less in the prediction made by the overall model F(x).

Training of ensemble machine learning models formulated as a QUBO problem: The resulting ensemble model, F(x), is a strong classifier. Let y be the output or prediction result of F(x). Then, as indicated above,

$$y = F ( x ) = sign ( {\sum }_{i = 1}^{N} {w}_{i} {f}_{i} ( x ) )$$

Recall, x∈ [symbol] ^{d}, y∈{31 1, 1}, fᵢx→{−1, 1}, wᵢ∈[0,1], and N is the number of classifiers.

Neven, et al. (2008) have studied how to make the training of binary classifiers of the above form amenable to quantum computing (Neven, et al. (2008), “Training a binary classifier with the quantum adiabatic algorithm”, arXiv:0811.0416). Training such a classifier (i.e., determining the weights, wᵢ, for the individual classifiers of the ensemble) is done by simultaneously minimizing two terms. The first term is the measure of the error over a set of m training examples. Recall from above that our training examples are input and expected output pairs (x₁, y₁), (x₂, y₂), . . . , (xₘ, yₘ). One intuitive way of measuring the prediction error for the ensemble model (e.g., the AdaBoost model comprising multiple weak classifiers) is simply to calculate the number of misclassifications made in processing the training set.

For each training example,

$${y}_{s}^{′} = sign ( {\sum }_{i = 1}^{N} {w}_{i} {f}_{i} ( {x}_{s} ) )$$

where y′ₛ is the predicted output. Since y′ₛ ∈{−1, 1}, and yₛ E {—Li}, whenever y′ₛ and yₛ are in agreement their product is 1. Whenever they differ, their product is −1. Using this observation, the loss function which counts the number of misclassifications can be written as:

$$L ( w ) = {\sum }_{s = 1}^{m} H ( - {y}_{s} {\sum }_{i = 1}^{N} {w}_{i} {f}_{i} ( {x}_{s} ) )$$

Since the value of term Σᵢ₋₁^{N} wᵢfᵢ(xₛ) is in the range [−1, 1], the sign function simply assigns the output value {−1, 1} based on whether the sum was positive or negative. Then the term −yₛ Σᵢ₌₁^{N}wᵢfᵢ(xₛ) will be negative when yₛ and Σᵢ₌₁^{N}wᵢf₁ are both positive or both negative (i.e., a correct classification is made), and positive when there has been a misclassification. By using the Heaviside step function, H, a positive value for −yₛΣᵢ₌₁^{N} wᵢfᵢ(xₛ) is re-assigned a value of 1, and a negative value is re-assigned a value of 0. Thus L(w), will count the number of misclassifications.

The second term to be minimized is a regularization function that will help prevent overlearning by preventing the classifier from becoming too complex. A good choice for the regularization term is the 0-norm, that will count the number of non-zero weights, and a control variable, λ, that will control the relative importance of the regularization. The regularization function is thus:

$$R ( w ) = λ {‖ w ‖}_{0} = λ {\sum }_{i = 1}^{N} {w}_{i}^{0}$$

Since the training of the ensemble model is equivalent to the minimization of these two terms to determine an optimal set of relative weights, w^{opt}, for the models in the ensemble, this gives the following optimization problem:

$${w}^{opt} = arg {min}_{i} ( L ( w ) + R ( w ) )$$

Neven, et al. (2008) state that since the loss function is not convex and the regularization is performed using the 0-norm, the optimization problem is likely to be NP-hard.

The problem becomes how to convert the optimization problem above into a format that can be used with adiabatic quantum computing (AQC). As formulated above, the weights for the classifiers are continuous in the range [0,1]. In order to solve the optimization problem using quantum computing, they need to be binary variables, and can be converted using a binary expansion. According to Neven et al. (2008), binary variables may be associated with a qubit (or quantum bit)−the basic unit of quantum information corresponding to a classic binary bit that is physically realized in a conventional two-state computing device. The number of bits needed (by a classical computer) for the expansion of a floating point number should be minimal since the number of qubits for any system is finite. It turns out that for many problems only a few bits are needed, and in some cases, only a single bit is required. The solution for the optimization problem outlined above states that the number of bits required is given by b≥log₂(f)+log₂(e)−1, where e is Euler's number and f=S/N, and where S is the number of training samples and N is the number of weak classifiers in the ensemble. The number of bits needed grows logarithmically based on the ratio of the number of training samples and the number of weak classifiers. In some instances, for example, the number of bits required may be 1, 2, 4, 8, 16, or 32 bits (or any number of bits within this range). In some instances, the number of bits required may be more than 32 bits.

The second modification that is required to solve the optimization problem using quantum computing is based on the limitations of current quantum computing devices. Current quantum computing devices require a Hamiltonian that has at most quadratic terms. Due to these requirements, the exponential loss function must be expressed as a quadratic loss function. The optimization problem now becomes:

$${w}^{opt} = arg {min}_{w} ( {\sum }_{s = 1}^{S} {\vert {\sum }_{i = 1}^{N} {w}_{i} {h}_{i} ( {x}_{s} ) - {y}_{s} \vert}^{2} + λ {‖ w ‖}_{0} )$$

Expanding the terms, substituting for λ∥w∥₀, and pulling out common terms gives:

$$= arg {min}_{w} ( {\sum }_{i = 1}^{N} {\sum }_{j = 1}^{N} {w}_{i} {w}_{j} ( {\sum }_{s = 1}^{S} {h}_{i} ( {x}_{s} ) {h}_{j} ( {x}_{s} ) ) + {\sum }_{i = 1}^{N} {w}_{i} ( λ - 2 {\sum }_{s = 1}^{S} {h}_{i} ( {x}_{s} ) {y}_{s} ) )$$

Neven, et al. (2008) state that for the quadratic loss function to be compatible with the sign function in a strong binary classifier that enforces a binary decision, the output should be scaled as

$${h}_{i} : x \to \{ - \frac{1}{N} , \frac{1}{N} \} .$$

The above equation constitutes a quadratic unconstrained binary optimization (QUBO) problem that may be solved using a quantum computing platform. This QUBO equation only holds in the case that a single bit on a classical computer suffices to adequately describe the problem; modifications to the equation are required if the number of bits required increases.

Executing the approach on a quantum computer: D-Wave, one non-limiting example of a quantum computing platform, houses a GitHub repository with a QBoost implementation. The repository provides code for a Python class that is a boosting method based on AdaBoost. It also contains a class for QBoost that first fits the weak classifiers to obtain a strong binary classifier of the form:

$$y = F ( x ) = sign ( {\sum }_{i = 1}^{N} {w}_{i} {f}_{i} ( x ) )$$

After the individual classifiers are fit to the training data, a QUBO for the ensemble model is created based on the above formulation of the optimization problem and the D-Wave code. The ensemble model is then optimized using D-Wave's quantum computer that takes the optimal solution as estimator weights to determine the minimum number of weak classifiers needed for the decision ensemble. The code was modified to incorporate the trust-based loss function as described above. This approach may be applicable to any quantum computing platform that is configured to solve QUBO problems.

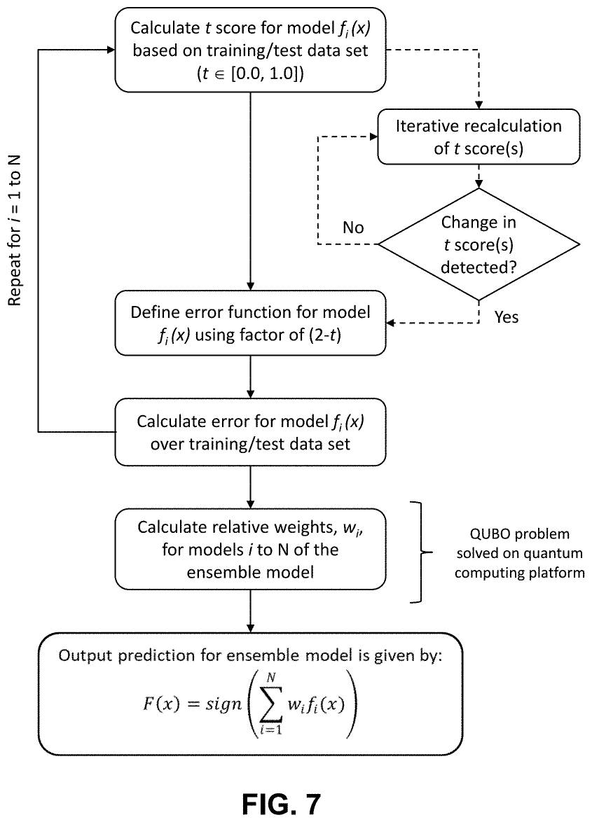

FIG. 7 provides a non-limiting example of a workflow for detecting adversarial attacks on an ensemble machine learning model using trust scores, and mitigating the effects of the attack by rapidly updating the relative weights of individual models and the output prediction equation for the ensemble model. As disclosed herein, a trust score may be calculated for a plurality of machine learning models incorporated into an ensemble model, and subsequently used to define a new loss-based error function comprising a factor of (2−t) for each model. The error functions are then used to calculate errors for the individual machine learning models, fᵢ (x), (using the revised relative weights of the training data points as determined by training the previous model, fᵢ₋₁(x), in the series of individual models), which in turn are used to determine the relative weights of the individual models in adjusting the prediction output for the ensemble model. In some instances, the latter calculation may be performed by formulating the calculation as a QUBO problem that may be solved on a quantum computing platform, as outlined above. In some instances, trust scores for the individual models may be recalculated at intermittent, periodic, or random times, and the detection in a change in the trust score for one or more of the individual models may be indicative of the model having been subjected to an adversarial attack. MNIST data, for example, could be used as test data to detect adversarial attack on a computer vision system; such an attack may comprise, for example, a patch-based attack that modifies a small set of pixels in the training data used to train a model that thereby causes the model to misclassify images. In some instances, the detection of a change in the trust score for one or more of the individual models may trigger a recalculation of errors and relative weights of the individual models, and thus may adjust their relative contributions to the output prediction of the ensemble model. The disclosed methods and systems thus provide a mechanism for detection of adversarial attacks and mitigation of their impact on the ensemble model. In the event that an adversarial attack has been detected, options for mitigating the impact of the attack may comprise, for example, reconditioning the trust score for that model and recalculating the weights for the ensemble model, changing the fusion scheme used for a heterogeneous ensemble model (i.e., a plurality of classification models trained using various classification algorithms and combined to output a more accurate prediction result than would be produced using a single classification algorithm) to discount the overall impact of a specific type of classification as being prone to error, and/or removing the compromised model from the ensemble.

QUBO problems: Quadratic unconstrained binary optimization (QUBO) problems are combinatorial optimization problems with applications in fields ranging from finance and economics to machine learning, and are currently one of the most prevalent problem classes for adiabatic quantum computing, where they are solved using the process of quantum annealing. For a quadratic polynomial function of binary variables,

f_{Q}(x)=Σᵢ₌₁ⁿρⱼ₌₁ⁱqᵢⱼxᵢxⱼ

where xᵢ∈B (where B={0, 1}) for i∈[n] and coefficients qᵢⱼ∈R (real numbers) for 1≤j≤i≤n, and where [n] is the set of positive integers of value ≤n, the QUBO problem consists of finding a binary vector x* that minimizes (or maximizes) f_{Q}(x) relative to all other possible binary vector solutions, i.e., x*=arg min f_{Q}(x) for x∈Bⁿ.

QUBO problems belong to a class of problems known to be “NP-hard”. The practical meaning of this is that “exact solvers” designed to find optimal solutions of such problems will most likely be unsuccessful except for in a very small number of problem instances. When using exact solver methods, real world-sized problems can run for days and weeks without producing high quality solutions (Glover, et al. (2019), “Quantum Bridge analytics I: a tutorial on formulating and using QUBO models”).

Quantum computing platforms: In some instances, all or a portion of the methods described herein, e.g., the training and optimization of an ensemble machine learning model, may be performed on a quantum computing platform. Quantum computing is an emerging computational paradigm that exploits quantum-mechanical principles such as entanglement and superposition, and that has the potential to outperform conventional computing approaches in solving complex and computationally intractable problems in a variety of fields (Gill, et al. (2020), “Quantum computing: a taxonomy, systematic review and future directions”, arXiv:2010.15559). In recent years, progress has been made in both quantum hardware development and quantum software/algorithm development.

In conventional digital computing, information is stored and processed as “bits” which may have a binary value of either “0” or “1”. The equivalent in quantum computing is known as a quantum bit (or qubit), which by virtue of quantum mechanical properties such as superposition may have values of “0”, “1”, or any superposition of “0” and “1” (i.e., a qubit may be in both the “0” and “1” states simultaneously) (Gill, et al. (2020)). Quantum computers can therefore access an exponentially large computational space, where n qubits may be in a superposition state of 2ⁿ possible outcomes at any given time. This feature may enable quantum computers to successfully solve a number of data intensive problems that are intractable or extremely time-consuming using conventional computers, such as analysis of chemical systems, finding solutions to complex optimization problems, and cryptography code-breaking.

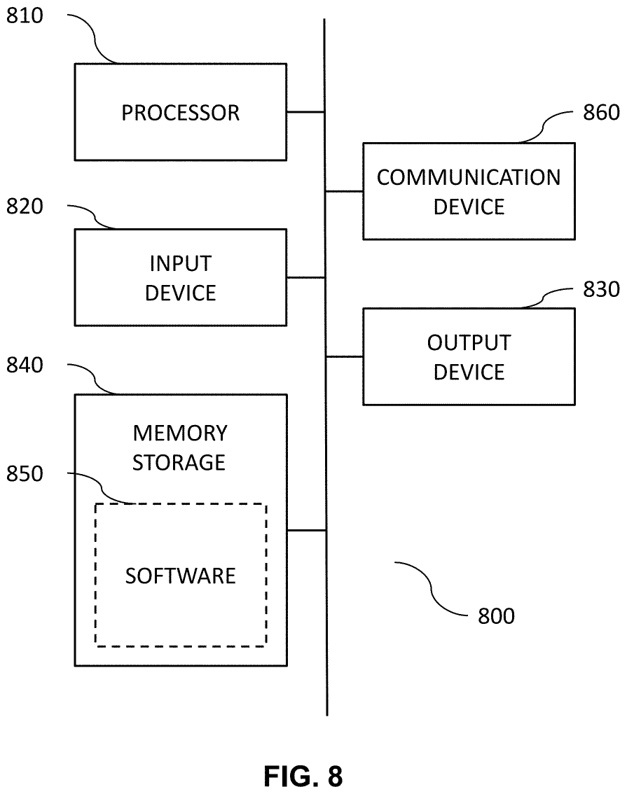

Computing devices and systems: FIG. 8 illustrates an example of a conventional computing device in accordance with one or more examples of the disclosure. Device 800 can be a host computer connected to a network. Device 800 can be a client computer or a server. As shown in FIG. 8, device 800 can be any suitable type of microprocessor-based device, such as a personal computer, workstation, server, or handheld computing device (portable electronic device), such as a phone or tablet. The device can include, for example, one or more of processor 810, input device 820, output device 830, storage 840, and communication device 860. Input device 820 and output device 830 can generally correspond to those described above, and they can either be connectable or integrated with the computer.

Input device 820 can be any suitable device that provides input, such as a touch screen, keyboard or keypad, mouse, or voice-recognition device. Output device 830 can be any suitable device that provides output, such as a touch screen, haptics device, or speaker.

Storage 840 can be any suitable device that provides storage, such as an electrical, magnetic, or optical memory including a RAM, cache, hard drive, or removable storage disk. Communication device 860 can include any suitable device capable of transmitting and receiving signals over a network, such as a network interface chip or device. The components of the computer can be connected in any suitable manner, such as via a physical bus or wirelessly.

Software 850, which can be stored in memory/storage 840 and executed by processor 810, can include, for example, the programming that embodies the functionality of the present disclosure (e.g., as embodied in the devices described above).

Software 850 can also be stored and/or transported within any non-transitory computer-readable storage medium for use by or in connection with an instruction execution system, apparatus, or device, such as those described above, that can fetch instructions associated with the software from the instruction execution system, apparatus, or device and execute the instructions. In the context of this disclosure, a computer-readable storage medium can be any medium, such as storage 840, that can contain or store programming for use by or in connection with an instruction execution system, apparatus, or device.

Software 850 can also be propagated within any transport medium for use by or in connection with an instruction execution system, apparatus, or device, such as those described above, that can fetch instructions associated with the software from the instruction execution system, apparatus, or device and execute the instructions. In the context of this disclosure, a transport medium can be any medium that can communicate, propagate, or transport programming for use by or in connection with an instruction execution system, apparatus, or device. The transport readable medium can include, but is not limited to, an electronic, magnetic, optical, electromagnetic, or infrared wired or wireless propagation medium.

Device 800 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

Device 800 can implement any operating system suitable for operating on the network. Software 850 can be written in any suitable programming language, such as C, C++, Java, or Python. In various embodiments, application software embodying the functionality of the present disclosure can be deployed in different configurations, such as in a client/server arrangement or through a web browser as a web-based application or web service, for example.

Quantum computing platforms: In some instances, all or a portion of the methods described herein, e.g., the optimization of weights for an ensemble machine learning model, may be performed on a quantum computing platform. Quantum computing is an emerging computational paradigm that exploits quantum-mechanical principles such as entanglement and superposition, and that has the potential to outperform conventional computing approaches in solving complex and computationally intractable problems in a variety of fields (Gill, et al. (2020), “Quantum computing: a taxonomy, systematic review and future directions”, arXiv:2010.15559). In recent years, progress has been made in both quantum hardware development and quantum software/algorithm development.

In conventional digital computing, information is stored and processed as “bits” which may have a binary value of either “0” or “1”. The equivalent in quantum computing is known as a quantum bit (or qubit), which by virtue of quantum mechanical properties such as superposition may have values of “0”, “1”, or any superposition of “0” and “1” (i.e., a qubit may be in both the “0” and “1” states simultaneously) (Gill, et al. (2020)). Quantum computers can therefore access an exponentially large computational space, where n qubits may be in a superposition state of 2′ possible outcomes at any given time. This feature may enable quantum computers to successfully solve a number of data intensive problems that are intractable or extremely time-consuming using conventional computers, such as analysis of chemical systems, finding solutions to complex optimization problems, and cryptography code-breaking.

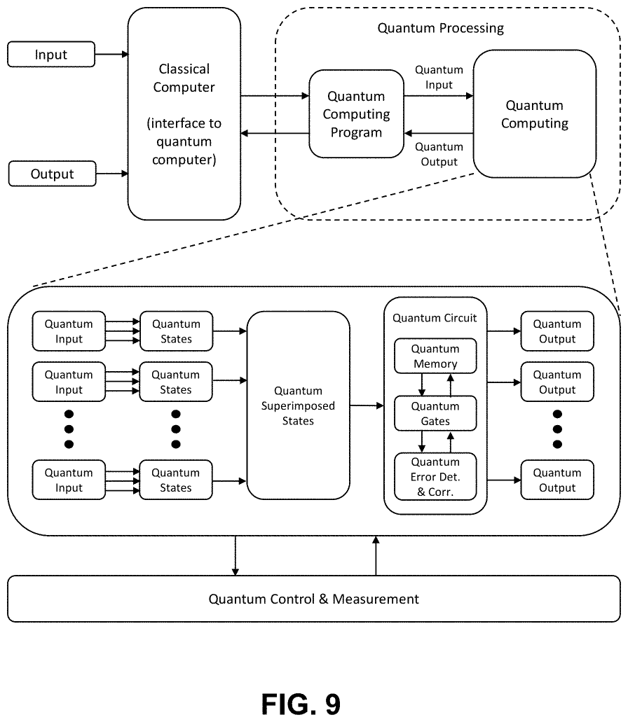

The basic building blocks of a quantum computer are shown schematically in FIG. 9, and consist of, e.g., quantum central processing units comprising quantum gates, quantum memory, and quantum error detection and correction, and quantum control and measurement mechanisms, where the input and output for the quantum computing platform is controlled by a quantum computing program (Gill, et al. (2020)). In some instances, quantum computers may deploy conventional computers for performing tasks at which conventional computers excel, e.g., providing user interfaces, networks, and data pre-processing and/or storage functions. In some instances, quantum computers may be controlled by conventional computers for performing complex computations.

The quantum gates in a quantum computer are the basic quantum operators that operate on a single qubit (or on a small number of qubits), can be deployed in various arrangements (or “quantum circuits”) depending on the application, and function to perform unitary operations. Examples of quantum gates include, but are not limited to, Hadamard gates, Pauli-X gates, Pauli-Y gates, Pauli-Z gates, Square root of NOT gates, Phase shift gates, Swap gates, Square root of swap gates, Controlled (CX CY CZ) gates, Toffoli (CCNOT) gates, Fredkin (CSWAP) gates, Ising (XX) coupling gates, Ising (YY) coupling gates, and Ising (ZZ) coupling gates, which are defined by the unitary operations that they perform. Quantum gates and quantum circuits may be implemented using, e.g., superconducting circuits that exhibit quantum properties such as entanglement, quantized energy levels, and superposition. In the case of superconducting circuits, typical qubit configurations include phase qubits, charge cubits, and flux cubits, for which the logical quantum states “0” or “1” are mapped to different states of the physical system, e.g., discrete (quantized) energy levels of the physical system (with typical energy level separations of about 5 GHz), or a quantum superposition thereof. In the charge qubit, the different energy levels typically correspond to an integer number of Cooper pairs (e.g., pairs of electrons bound together at low temperature) on a superconducting island. In the flux qubit, the energy levels typically correspond to different integer numbers of magnetic flux quanta trapped in a superconducting ring. In the phase qubit, the energy levels typically correspond to different quantum charge oscillation amplitudes across a Josephson junction.

Other examples of approaches for implementation of quantum gates and quantum circuits that are under development include, but are not limited to, approaches utilizing trapped ions, optical lattices, spin state, and spatial arrays of quantum dots, quantum wells, quantum wires, nuclear magnetic resonance (NMR), solid-state NMR, molecular magnets, cavity quantum electrodynamics, linear optics, Bose-Einstein condensates, rare earth metal ion-doped inorganic crystals, and metallic-like carbon nanospheres (Gill, et al. (2020)).

Quantum error detection and correction tools are used to locate and correct errors that may occur during the operations performed by the quantum gates. Quantum memory uses quantum registers to save the quantum states of the quantum circuit. In some instances, quantum memory has been realized using arrays of quantum states to form a stable quantum system. The quantum central processing unit is an integral part of the quantum computer that uses a quantum bus for communication with the other units of the quantum computer. Quantum control and measurement mechanisms are required to implement and monitor the manipulation of quantum states and quantum computations while handling the error detection and correction processes. Examples of quantum control and measurement mechanisms (which may depend on the specific implementation of the quantum gate structures) for superconducting quantum computing include, but are not limited to, the use of waveform generators (e.g., custom digital-to-analog (DAC) boards) to generate control waveforms which may be up-converted to the GHz qubit frequency range using, e.g., an IQ mixer and microwave source, and transmitted to the superconducting circuit using a combination of attenuators and low-pass filters (Chen (2018), “Metrology of Quantum Control and Measurement in Superconducting Qubits”, Ph.D. thesis, University of California, Santa Barbara). Readout waveforms may be generated in a similar fashion and reflected off of the superconducting circuit, followed by amplification of the output signal using, e.g., reflective, impedance-matched parametric amplifiers, high electron mobility transistors (HEMT), room temperature amplifiers, and custom analog-to-digital (ADC) boards, to measure changes in quantum state. In some instances, the qubit energy level separation may be adjusted by means of, e.g., controlling a dedicated bias current, thereby providing a “knob” to fine tune the qubit parameters.

Examples of quantum computing platforms that are currently accessible and/or under development include, but are not limited to, the Amazon Bracket, Azure Quantum, D-Wave, or TensorFlow Quantum computing platforms. Some of these platforms, e.g., the D-Wave platform, may comprise qubits that are configured to implement quantum annealing processes rather than a more general approach to quantum computing.

Quantum annealing (including adiabatic quantum computation) is a quantum computing method used to find the optimal solution of problems (e.g., optimization problems) involving a large number of possible solutions that takes advantage of properties specific to quantum physics like quantum tunneling, entanglement and superposition (Dilmegani (2021), “Quantum annealing in 2021: practical quantum computing”, AIMultiple, January 2021). Adiabatic processes are thermodynamic processes in which there is no transfer of heat or mass between a system and its surroundings, i.e., energy is transferred only in the form of work. A common example is the annealing process comprising the heating and then slow cooling of a metal used in metallurgy to alter the properties of a metal, e.g., its hardness. Quantum annealing works in a similar way, where the total energy of the system corresponds to “temperature” and the lowest energy state for the system, i.e., the global minimum, is found via “annealing”. In quantum annealing, each possible state is represented as an energy level. Starting with the system placed in a quantum mechanical superposition of all possible states, with each state having an equal weight, the system is allowed to quickly evolve according to the time-dependent Schrodinger equation which describes the quantum mechanical evolution of a physical system. The amplitudes of all possible states vary according to quantum fluctuations, e.g., perturbations arising from the time-dependent strength of an applied electromagnetic field, which cause quantum tunneling between states. The lowest total energy state for the system gives the optimal solution or the most likely solution. Quantum annealing performs better than conventional computational methods for solving a number of optimization problems of importance in fields ranging from healthcare to finance (Dilmegani (2021)).

It should be understood from the foregoing that, while particular implementations of the disclosed methods, devices, and systems have been illustrated and described, various modifications can be made thereto and are contemplated herein. It is also not intended that the invention be limited by the specific examples provided within the specification. While the invention has been described with reference to the aforementioned specification, the descriptions and illustrations of the preferable embodiments herein are not meant to be construed in a limiting sense. Furthermore, it shall be understood that all aspects of the invention are not limited to the specific depictions, configurations or relative proportions set forth herein which depend upon a variety of conditions and variables. Various modifications in form and detail of the embodiments of the invention will be apparent to a person skilled in the art. It is therefore contemplated that the invention shall also cover any such modifications, variations and equivalents.

What is claimed is:

1. A method for training an ensemble machine learning model comprising:
a) receiving data characterizing levels of trust in a plurality of machine learning models, wherein the plurality of machine learning models collectively form at least part of the ensemble machine learning model;
b) calculating a prediction error estimate for each machine learning model of the plurality, wherein the prediction error estimate for each machine learning model is based on a trust score for that machine learning model and relative weights calculated for at least a subset of the data points in a training data set used to train that machine learning model;
c) calculating a normalized weight for each machine learning model of the plurality using the prediction error estimate calculated in (b) for each machine learning model of the plurality; and
d) determining an output prediction equation for the ensemble machine learning model, wherein the determination is based, at least in part, on the normalized weights calculated in (c) for each machine learning model of the plurality.

2. The method of claim 1, wherein the data characterizing a level of trust in each machine learning model of the plurality comprises a trust score for each machine learning model of the plurality.

3. The method of claim 2, wherein the trust score is a real number having a value ranging from 0.0 to 1.0.

4. The method of claim 2, wherein the trust score for each machine learning model of the plurality is calculated from the received data.

5. The method of claim 4, wherein the received data comprises data relating to a sensitivity of model predictions to input data quality, a sensitivity of model predictions to distributional shifts of training data input, a sensitivity of model predictions to out-of-distribution (OOD) input data, a posterior distribution of model predictions, prediction confidence scores aggregated across one or more training data sets, a ratio of calculated nearest neighbor distances for interclass and intraclass predictions, one or more model performance metrics, or any combination thereof.

6. The method of claim 1, wherein the prediction error estimate is calculated for each machine learning model of the plurality using a loss-based penalty function for that machine learning model that is based, at least in part, on the trust score for that machine learning model.

7. The method of claim 6, wherein the loss-based penalty function for each machine learning model of the plurality comprises a factor of (2−t), where t is the trust score for that machine learning model and has a value of 0≤t≤1.

8. The method of claim 7, wherein the prediction error estimate calculation for each machine learning model of the plurality comprises a sum of loss-based penalty function terms each comprising a product of a relative weight for a training data point for which that machine learning model prediction was incorrect and a factor of (2−t), where t is the trust score for that machine learning model.

9. The method of claim 8, wherein the prediction error estimate for each machine learning model of the plurality is calculated according to the equation:
$$e r r = {\sum }_{i = 1}^{m} {D}_{j} ( i ) ( h ( {x}_{i} ) \neq {y}_{i} ) * ( 2 - t )$$
wherein m is a number of labeled training data point pairs in a training data set used to train a given machine learning model of the plurality of machine learning models, Dⱼ(i) is a normalized weight for an i^{th} training data point for the j^{th} machine learning model, (h(xᵢ)≠yᵢ) is a subset of training data points for which the given machine learning model's predicted output value, h(xᵢ), does not equal a known value, yᵢ, and t is the trust score for the given machine learning model.

10. The method of claim 1, wherein the output prediction of the ensemble machine learning model is given by the equation:
$$F ( x ) = sign ( {\sum }_{i = 1}^{N} {w}_{i} {f}_{i} ( x ) )$$
wherein F(x) is a prediction of the ensemble machine learning model for input data value x, N is a number of machine learning models in the ensemble machine learning model, wᵢ are normalized weights for the plurality of machine learning models that collectively form at least part of the ensemble machine learning model, and fᵢ(x) are predictions of the individual machine learning models in the ensemble for input data value x.

11. The method of claim 10, wherein the normalized weight, wᵢ, for each machine learning model of the plurality is calculated, at least in part, by taking a natural logarithm of a quotient comprising the prediction error estimate for that machine learning model.

12. The method of claim 11, wherein the normalized weight, wᵢ, for each machine learning model of the plurality is calculated, at least in part, according to the equation:
$${w}_{i , n o n - normalized} = \frac{1}{2} ln ( \frac{1 - e r {r}_{i}}{e r {r}_{i}} )$$
wherein errᵢ is the prediction error estimate calculated for the i^{th} machine learning model of the plurality, wherein
wᵢ=w_{i,non-normalized}/Σᵢ₌₁^{N}w_{i,non-normalized}
and wherein N is a number of individual machine learning models in the ensemble machine learning model.

13. The method of claim 10, wherein the normalized weights for the individual machine learning models of the ensemble machine learning model are calculated by:
a) reformulating the output prediction equation in the form of a quadratic unconstrained binary optimization (QUBO) problem; and
b) using a quantum computing method to solve the QUBO problem for the normalized weights, wᵢ, for the one or more machine learning models.

14. The method of claim 1, further comprising receiving additional data characterizing levels of trust in one or more machine learning models of the plurality and re-adjusting the output prediction equation for the ensemble if a change in a level of trust is detected for one or more machine learning models of the plurality.

15. The method of claim 1, wherein one or more of the machine learning models of the plurality of machine learning models comprises a classifier model.

16. The method of claim 15, wherein the classifier model comprises an artificial neural network (ANN), deep learning algorithm (DLA), decision tree algorithm, Naïve Bayes algorithm, support vector machine (SVM), or k-nearest neighbor (KNN) algorithm.

17. The method of claim 1, wherein the ensemble machine learning model is trained using an AdaBoost method.

18. A method for training an ensemble machine learning model comprising:
a) receiving data characterizing levels of trust in a plurality of machine learning models, wherein the plurality of machine learning models collectively form at least part of the ensemble machine learning model;
b) training individual machine learning models of the ensemble machine learning model using an AdaBoost method, wherein the training comprises the use of a loss-based penalty function for each machine learning model of the plurality to calculate a prediction error estimate for that machine learning model, and wherein the prediction error estimate is based on a trust score for that machine learning model and relative weights calculated for at least a subset of data points in a training data set used to train that machine learning model; and
c) calculating a normalized weight for each individual machine learning model of the ensemble; and
d) determining an output prediction equation for the ensemble machine learning model, wherein the normalized weights calculated in (c) are used to formulate the output prediction equation for the ensemble machine learning model.

19. The method of claim 18, further comprising formulating the output prediction equation for the ensemble machine learning model as a sum of two terms:
a) an exponential loss function term that provides a measure of a total number of errors made by the ensemble machine learning model as a function of the normalized weights, wᵢ, for the individual machine learning models of the ensemble in predicting a result, y′ₛ, for a given input value, xₛ, when processing a training data set comprising labeled training data points, (xₛ, yₛ); and
b) a regularization term that comprises a product of (i) a sum of non-zero normalized weights, wᵢ⁰, for the individual of machine learning models of the ensemble and (ii) a control variable, λ; and
minimizing the two terms of the output prediction equation to determine the normalized weights, wᵢ, for the plurality of machine learning models.

20. The method of claim 19, wherein the minimizing is performed by
a) converting the normalized weights, wᵢ, for the plurality of machine learning models to binary values using a binary expansion;
b) rewriting the exponential loss function as a quadratic loss function;
c) expanding and combining the quadratic loss function term, the binary values of the normalized weights, wᵢ, and the regularization term to formulate a quadratic unconstrained binary optimization (QUBO) problem; and
d) solving the QUBO problem using a quantum computing platform.

21. The method of claim 18, wherein the ensemble machine learning model is a binary classifier.

22. The method of claim 20, wherein the binary values derived from binary expansion of the normalized weights, wᵢ, for the plurality of machine learning models comprise qubits.

23. The method of claim 22, wherein the minimum number of qubits, b, required for the binary expansion is given by b≥log₂(f)+log2(e)−1, where e is Euler's number, f=S/N, S is the number of training data point pairs, and N is the number of individual machine learning models in the ensemble machine learning model.

24. The method of claim 23, wherein b<32.

25. The method of claim 23, wherein b=1.

26. The method of claim 25, wherein the quadratic unconstrained binary optimization (QUBO) is expressed as:
$${w}^{opt} = arg {min}_{w} ( {\sum }_{i = 1}^{N} {\sum }_{j = 1}^{N} {w}_{i} {w}_{j} ( {\sum }_{s = 1}^{S} {h}_{i} ( {x}_{s} ) {h}_{j} ( {x}_{s} ) ) + {\sum }_{i = 1}^{N} {w}_{i} ( λ - 2 {\sum }_{s = 1}^{S} {h}_{i} ( {x}_{s} ) {y}_{s} ) )$$
wherein w^{opt} is a set of optimized weights for a binary classifier which is used to weight predictions of the individual machine learning models.

27. The method of claim 18, further comprising receiving additional data characterizing levels of trust in one or more machine learning models of the plurality and re-calculating the normalized weight for each individual machine learning model of the ensemble if a change in a level of trust is detected for one or more machine learning models of the plurality.

28. The method of claim 20, wherein the quantum computing platform comprises an Amazon Bracket, Azure Quantum, D-Wave, or TensorFlow Quantum quantum computing platform.

29. A system comprising:
one or more processors;
memory; and
one or more programs stored in the memory and comprising instructions that, when executed by the one or more processors, cause the one or more processors to:
a) receive data characterizing levels of trust in a plurality of machine learning models, wherein the plurality of machine learning models collectively form at least part of the ensemble machine learning model;
b) calculate a prediction error estimate for each machine learning model of the plurality, wherein the prediction error estimate for each machine learning model is based on a trust score for that machine learning model and relative weights calculated for at least a subset of the data points in a training data set used to train that machine learning model;
c) calculate a normalized weight for each machine learning model of the plurality using the prediction error estimate calculated in (b) for each machine learning model of the plurality; and
d) determine an output prediction equation for the ensemble machine learning model, wherein the determination is based, at least in part, on the normalized weights calculated in (c) for each machine learning model of the plurality.

30. A non-transitory, computer-readable medium storing one or more programs, the one or more programs comprising instructions which, when executed by one or more processors of an electronic device or system, cause the electronic device or system to:
a) receive data characterizing levels of trust in a plurality of machine learning models, wherein the plurality of machine learning models collectively form at least part of the ensemble machine learning model;
b) calculate a prediction error estimate for each machine learning model of the plurality, wherein the prediction error estimate for each machine learning model is based on a trust score for that machine learning model and relative weights calculated for at least a subset of the data points in a training data set used to train that machine learning model;
c) calculate a normalized weight for each machine learning model of the plurality using the prediction error estimate calculated in (b) for each machine learning model of the plurality; and
d) determine an output prediction equation for the ensemble machine learning model, wherein the determination is based, at least in part, on the normalized weights calculated in (c) for each machine learning model of the plurality.
